(19) United States
(12) Patent Application Publication
(10) Pub. No.: US 2024/0067033 A1
(43) Pub. Date: Feb. 29, 2024

(54) MANAGEMENT SERVER, MANAGEMENT METHOD, AND NON-TRANSITORY STORAGE MEDIUM

(71) Applicant: NEC Corporation, Tokyo (JP)

(72) Inventors: Hideyuki ISHIUJI, Tokyo (JP); Hiromi SUZUKI, Tokyo (JP); Yutaka OKANO, Tokyo (JP); Sayaka ISHIMOTO, Tokyo (JP); Shoko YOKOTE, Tokyo (JP); Satoshi TANAKA, Tokyo (JP); Koji KITAHARA, Tokyo (JP); Megumi YAMAMOTO, Tokyo (JP); Chieko KURIBAYASHI, Tokyo (JP); Tomohide TOYODA, Tokyo (JP)

(73) Assignee: NEC Corporation, Tokyo (JP)

(21) Appl. No.: 18/237,443

(22) Filed: Aug. 24, 2023

(30) Foreign Application Priority Data
Aug. 29, 2022 (JP) 2022-135639

(51) Int. Cl. B60L 53/66; B60L 53/63

(52) U.S. Cl. CPC B60L 53/665; B60L 53/63; B60L 2250/00

(57) ABSTRACT

In order to achieve a charging service using an outlet of 100 V or 200V, the present invention provides a management server 10 including an acquisition unit 11 that acquires, from a user terminal, apparatus specifying information specifying a control apparatus that controls power supply to an outlet, and a control execution unit 12 that executes processing of controlling the control apparatus specified by the apparatus specifying information.

This application is based upon and claims the benefit of priority from Japanese patent application No. 2022-135639, filed on Aug. 29, 2022, the disclosure of which is incorporated herein in its entirety by reference.

### TECHNICAL FIELD

The present invention relates to a management server, a control system, a management method, a control method, and a program.

### BACKGROUND ART

A technique relating to the present invention is disclosed in Patent Document 1 (Japanese Patent Application Publication No. 2010-110044) and Patent Document 2 (Japanese Patent Application Publication No. 2011-186875).

Patent Document 1 discloses a charging apparatus for an electric vehicle, the apparatus including a power supply means, an operation terminal, and a control unit. The power supply means includes an outlet for supplying power to an electric vehicle. The operation terminal includes an information input means for enabling input of charging instruction information, an information display means, and a charge collection means for collecting a charge from a user. The control unit stores charging instruction information input from the information input means, and computes, for each outlet opening, charging reservation information including a charging start time, a charging end time, and a charging charge, and controls, based on the charging reservation information, energization based on the power supply means. Then, the charging instruction information includes a charging time, and the control unit computes, based on the charging time, a charging start time, a charging end time, and a charging charge.

Further, in the technique disclosed in Patent Document 1, in order to prevent electricity stealing and mischief, an outlet is accommodated in an outlet box equipped with a door, and the door is applied with a mechanical or electric lock. When there are an unspecified large number of users, the lock is released, for example, by using a password or the like set at a time of charging reservation.

Patent Document 2 discloses an electric car charging facility that receives input of identifier (ID) information of a user, decides, based on the ID information, use permission/non-permission, and starts, when permitted, charging to a vehicle of the user.

Patent Document 3 (Japanese Patent Application Publication No. 2022-048626) discloses a technique for efficiently distributing, to a purchase-desiring person, surplus power in generated power based on a power generator.

Patent Document 4 (Japanese Patent Application Publication No. 2018-147029) discloses a technique for enabling an individual to easily purchase or sell power.

### DISCLOSURE OF THE INVENTION

For prevalence of an electric car, a charging facility is expected to be consolidated. For example, a function of communicating with a vehicle and a dedicated charger including a high-speed charging function have been developed, but a problem in cost and the like is an obstacle to prevalence of the charger.

When a charging service can be provided by using an outlet of 100 V or 200 V being generally widespread, a problem in cost is reduced. Further, from a point of view of the convenience, it is expected that many business operators providing the charging service appear. However, in a charging service using such an outlet, there is a problem such as establishment of an electricity stealing prevention means and establishment of a settlement means for power use. In the technique disclosed in Patent Document 1, an outlet is accommodated in an outlet box equipped with a door and the door is applied with a mechanical or electric lock, and thereby electricity stealing prevention is achieved. Further, an advance reservation system is employed, and therefore a user using an outlet can be determined and settlement processing is made possible. However, in the technique disclosed in Patent Document 1, it is necessary to prepare, for each outlet, an outlet box equipped with a door. There is a problem in effort and an expense required for preparation and maintenance management of such an outlet box. Further, some users feel an advance reservation as being bothersome. In the technique disclosed in Patent Document 2, it is assumed that a dedicated charger is used, but it is not assumed that an outlet of 100V or 200V is used. The techniques disclosed in Patent Documents 3 and 4 do not relate to a charging service using an outlet of 100V or 200V.

In view of the problem described above, one example of an object of the present invention is to provide a management server, a control system, a management method, a control method, and a program that solve an issue for achieving a charging service using an outlet of 100V or 200V.

According to one aspect of the present invention,

provided is a management server including:

an acquisition unit that acquires, from a user terminal, apparatus specifying information specifying a control apparatus that controls power supply to an outlet; and

a control execution unit that executes processing of controlling the control apparatus specified by the apparatus specifying information.

According to one aspect of the present invention,

provided is a control system including:

a request acquisition unit that acquires, from a management server, a request for starting power supply to a predetermined outlet and control content information indicating a charging power amount or a charging time; and

a power control unit that controls a control apparatus that controls power supply to an outlet, starts power supply to the outlet according to the request, and also stops power supply to the outlet according to completion of charging processing indicated by the control content information.

According to one aspect of the present invention,

provided is a management method including,

by one or more computers:
acquiring, from a user terminal, apparatus specifying information specifying a control apparatus that controls power supply to an outlet; and
executing processing of controlling the control apparatus specified by the apparatus specifying information.

According to one aspect of the present invention,

provided is a control method including,

by one or more computers:
acquiring, from a management server, a request for starting power supply to a predetermined outlet and control content information indicating a charging power amount or a charging time; and
controlling a control apparatus that controls power supply to an outlet, starting power supply to the outlet according to the request, and also stopping power supply to the outlet according to completion of charging processing indicated by the control content information.

According to one aspect of the present invention,

provided is a program for causing a computer to function as:

an acquisition unit that acquires, from a user terminal, apparatus specifying information specifying a control apparatus that controls power supply to an outlet; and

a control execution unit that executes processing of controlling the control apparatus specified by the apparatus specifying information.

According to one aspect of the present invention,

provided is a program for causing a computer to function as:

a request acquisition unit that acquires, from a management server, a request for starting power supply to a predetermined outlet and control content information indicating a charging power amount or a charging time; and

a power control unit that controls a control apparatus that controls power supply to an outlet, starts power supply to the outlet according to the request, and also stops power supply to the outlet according to completion of charging processing indicated by the control content information.

According to one aspect of the present invention, a management server, a control system, a management method, a control method, and a program that solve an issue for achieving a charging service using an outlet of 100V or 200V are achieved.

### BRIEF DESCRIPTION OF THE DRAWINGS

The above-described object, other objects, features, and advantages will become more apparent from a preferred example embodiment described below and the following accompanying drawings.

FIG. 1 is a diagram illustrating one example of a function block diagram of a management server.

FIG. 2 is a diagram illustrating one example of a function block diagram of a control system.

FIG. 3 is a diagram illustrating one example of a function block diagram of a system including the management server and the control system.

FIG. 4 is a diagram illustrating one example of a hardware configuration of the management server and the control system.

FIG. 5 is a diagram illustrating another example of a function block diagram of the control system.

FIG. 6 is a sequence diagram illustrating one example of a flow of processing of a system including the management server and the control system.

FIG. 7 is a sequence diagram illustrating another example of a flow of processing of the system including the management server and the control system.

FIG. 8 is a diagram illustrating another example of a function block diagram of the management server.

FIG. 9 is a diagram illustrating one example of a screen displayed in a user terminal.

FIG. 10 is a diagram illustrating another example of a screen displayed in the user terminal.

FIG. 11 is a diagram illustrating another example of a screen displayed in the user terminal.

FIG. 12 is a diagram illustrating another example of a screen displayed in the user terminal.

### DESCRIPTION OF EMBODIMENTS

Example embodiments of the present invention will be described below by using drawings. Note that, in every drawing, a similar component is given a similar sign, and description thereof is omitted as appropriate.

### First Example Embodiment

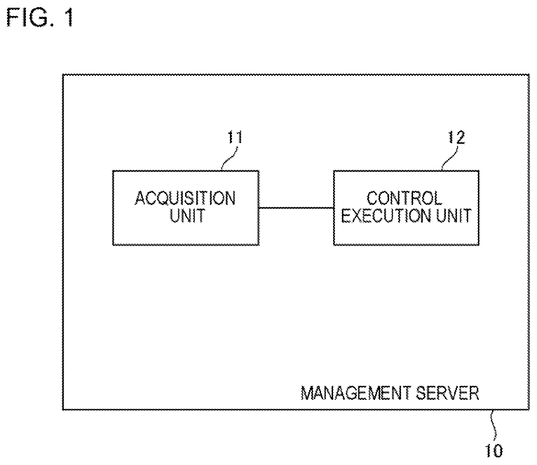

FIG. 1 is a function block diagram illustrating an outline of a management server 10 according to a first example embodiment. The management server 10 includes an acquisition unit 11, and a control execution unit 12. The acquisition unit 11 acquires, from a user terminal, apparatus specifying information specifying a control apparatus that controls power supply to an outlet. The control execution unit 12 executes processing of controlling the control apparatus specified by the apparatus specifying information.

By using the management server 10 including such a configuration, power supply to an outlet is stopped at a normal time, and power supply to the outlet can be started according to an operation via a user terminal. As a result, electricity stealing can be effectively reduced. Further, according to an operation from a user via the user terminal, power supply to an outlet is started, and therefore a billing party (the user) of a consideration for power use can be certainly determined. As a result, settlement processing can be certainly executed. Further, a user may perform, immediately before using a certain outlet, an operation for starting power supply to the outlet. As a result, the user can avoid bothersome work being an advance reservation.

According to the management server 10 according to the first example embodiment as described above, an issue for achieving a charging service using an outlet of 100V or 200V is solved.

### Second Example Embodiment

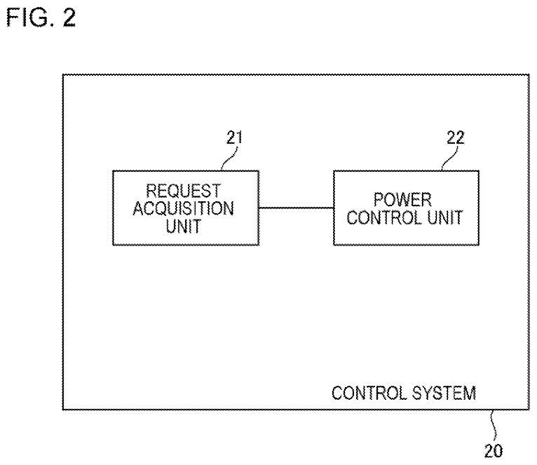

FIG. 2 is a function block diagram illustrating an outline of a control system 20 according to a second example embodiment. The control system 20 includes a request acquisition unit 21 and a power control unit 22. The request acquisition unit 21 acquires, from a management server 10, a request for starting power supply to a predetermined outlet and control content information indicating a charging power amount or a charging time. The power control unit 22 controls a control apparatus that controls power supply to an outlet, starts power supply to the outlet according to the request, and also stopping power supply to the outlet according to completion of charging processing indicated by the control content information.

By using the control system 20 including such a configuration, power supply to an outlet is stopped at a normal time, and power supply to an outlet specified according to a predetermined request from an external apparatus can be started. Then, according to completion of specified charging processing, power supply to the outlet can be stopped. As a result, electricity stealing can be effectively reduced.

According to the control system 20 according to the second example embodiment as described above, an issue for achieving a charging service using an outlet of 100V or 200V can be solved.

### Third Example Embodiment

### “Outline”

According to the present example embodiment, configurations of a management server 10 and a control system 20 are further embodied.

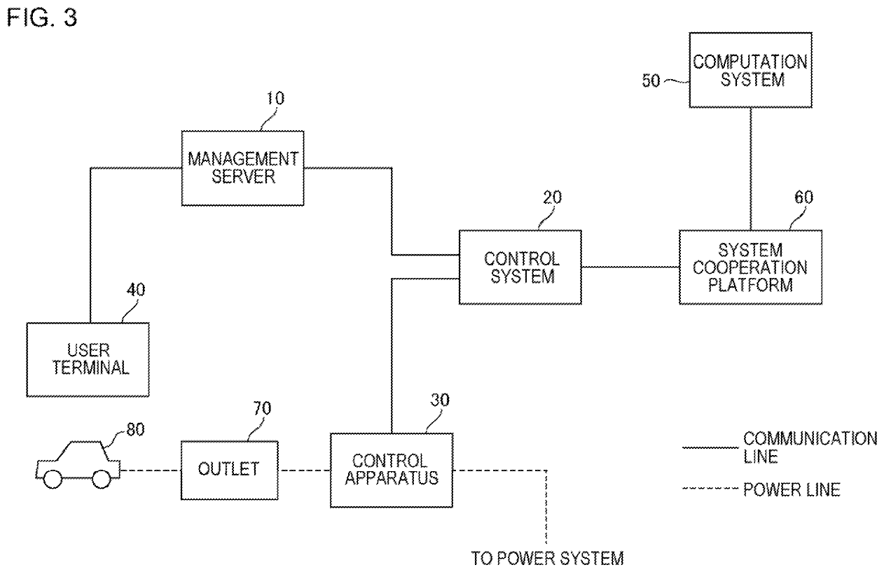

First, FIG. 3 illustrates a whole picture of a system including the management server 10 and the control system 20. Note that in FIG. 3, only components necessary for description are illustrated, and illustration of a component unnecessary for description is omitted as appropriate. According to the present example embodiment, a component being not illustrated can be added, as appropriate.

First, an outline of each of components illustrated in FIG. 3 is described. Note that, detailed description is made later.

The management server 10 is a server managed by a business operator providing a charging service using an outlet 70 of 100V or 200V. One example of the business operator is a power retail business operator. The business operator installs the outlet 70 for providing a charging service in any location such as a parking lot used by an unspecified large number of users. The business operator may install the outlet 70, for example, in a parking lot or the like owned by him/herself. Further, the business operator may make a predetermined contract with a manager of a facility such as an amusement park, a supermarket, a coin-operated parking lot, and a month-to-month parking lot, and install the outlet 70 in a parking lot and the like of the facility.

A control apparatus 30 controls, from a power system, power supply to the outlet 70. In other words, the control apparatus 30 stops or starts, from the power system, power supply to the outlet 70. The control apparatus 30 is a so-called smart meter. Note that, another apparatus including a function similar to the smart meter may be usable as the control apparatus 30. The control apparatus 30 is installed in the same area as in the outlet 70. The control apparatus 30 is managed by a power transmission and distribution business operator.

The control system 20 is a system that manages data, an operation, a facility, and the like of the control apparatus 30. The control system 20 is a so-called meter data management system (MDMS). Note that, another apparatus including a function similar to the MDMS may be usable as the control system 20. The control system 20 is managed by a power transmission and distribution business operator.

The user terminal 40 is a terminal used by a user using an electric car 80. The user terminal 40 is, for example, a smartphone, a tablet terminal, a smartwatch, a personal computer, a mobile phone, or the like.

The electric car 80 is a vehicle which travels by using a motor in which a power source is electricity. The electric car 80 may an ordinary vehicle (four-wheel vehicle), may be a two-wheel vehicle, may be a large-size vehicle, or may be a vehicle of another type.

A computation system 50 computes environment load information. The computation system 50 computes, for example, environment load information by region. The environment load information includes a greenhouse effect gas emission amount (carbon emission amount), and the like. The computation system 50 can compute at least one of so-called scopes 1 to 3, for example, an entire emission amount. The computation system 50 is managed by any business operator.

A system cooperation platform 60 manages, by region, information required for computing environment load information. The system cooperation platform 60 is managed by any business operator.

Next, an outline of processing achieved by such a system is described. Note that, detailed description is made later.

A user using a charging service transmits, to the management server 10 via the user terminal 40, “information specifying the control apparatus 30 that controls a predetermined outlet 70 to be used” and “charging-content specifying information specifying a power amount to be charged, a time required for executing charging processing, an amount of money to be paid in charging processing, a payment method, and the like”. The management server 10 having acquired the information executes predetermined processing such as authentication processing of a user and the like, and thereafter, transmits, to the control system 20, a request for starting power supply to the predetermined outlet 70. Further, the management server 10 transmits, to the control system 20, control content information indicating a charging power amount or a charging time.

The control system 20 having received the request and information controls the control apparatus 30 that controls power supply to the predetermined outlet 70 in such a way as to start power supply to the outlet 70 and also stop power supply to the outlet 70 according to completion of charging processing indicated by the control content information. The control apparatus 30 starts or stops, based on the control from the control system 20, power supply to the outlet 70. Further, the control apparatus 30 measures a power use amount via the outlet 70 during power supply to the outlet 70 based on the control, and transmits a measurement value to the control system 20. The control system 20 transmits the received measurement value to the management server 10. Further, the control system 20 can register the received measurement value in association with the outlet 70 or an installation location of the outlet 70.

The management server 10 communicates with the user terminal 40, and executes settlement processing based on the above-described measurement value and a payment method indicated by charging-content specifying information.

Further, the control system 20 can transmit, to the system cooperation platform 60, the registered measurement value in association with the outlet 70 or the installation location of the outlet 70. The system cooperation platform 60 transmits the received information to the computation system 50. The computation system 50 computes, based on the received information, environment load information by region.

### “Hardware Configuration”

Next, one example of a hardware configuration of each of the management server 10 and the control system 20 is described. Note that, at least some other components illustrated in FIG. 3 can also include a similar hardware configuration. Each function unit of the management server 10 and the control system 20 is achieved by any combination of hardware and software, mainly including a central processing unit (CPU) of any computer, a memory, a program loaded onto a memory, a storage unit (capable of storing, in addition to a program previously stored from a stage where an apparatus is shipped, a program downloaded from a storage medium such as a compact disc (CD), a server on the Internet, and the like) such as a hard disk storing the program, and a network connection interface. Then, it should be understood by those of ordinary skill in the art that, in an achievement method and an apparatus for the above, there are various modified examples.

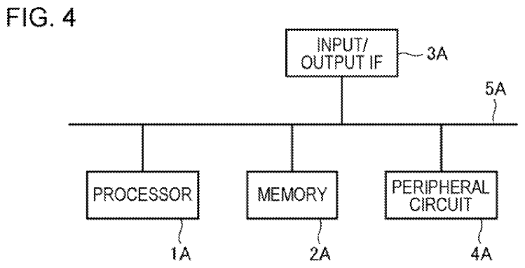

FIG. 4 is a block diagram illustrating a hardware configuration of the management server and the control system 20. As illustrated in FIG. 4, each of the management server 10 and the control system 20 includes a processor 1A, a memory 2A, an input/output interface 3A, a peripheral circuit 4A, and a bus 5A. The peripheral circuit 4A includes various modules. At least one of the management server 10 and the control system 20 may not necessarily include the peripheral circuit 4A. Note that, at least one of the management server 10 and the control system 20 may be configured by using a plurality of apparatuses separated physically and/or logically. In this case, each of the plurality of apparatuses can include the hardware configuration described above.

The bus 5A is a data transmission path in which the processor 1A, the memory 2A, the peripheral circuit 4A, and the input/output interface 3A mutually transmit/receive data. The processor 1A is an arithmetic processing apparatus, for example, such as a CPU and a graphics processing unit (GPU). The memory 2A is a memory, for example, such as a random access memory (RAM) and a read only memory (ROM). The input/output interface 3A includes an interface for acquiring information from an input apparatus, an external apparatus, an external server, an external sensor, a camera, and the like, an interface for outputting information to an output apparatus, an external apparatus, an external server, and the like, and the like. The input apparatus is, for example, a keyboard, a mouse, a microphone, a physical button, a touch panel, and the like. The output apparatus is, for example, a display, a speaker, a printer, a mailer, and the like. The processor 1A can issue an instruction to each module, and perform an arithmetic operation, based on arithmetic operation results of the modules.

### “Function Configuration”

### —Management Server 10—

Next, a function configuration of the management server 10 according to the present example embodiment is described in detail. FIG. 1 illustrates one example of a function block diagram of the management server 10. As illustrated, the management server 10 includes an acquisition unit 11 and a control execution unit 12.

The acquisition unit 11 acquires, from the user terminal 40, (1) apparatus specifying information, (2) charging-content specifying information, and (3) discrimination information of a user.

The “apparatus specifying information” is information specifying the control apparatus that controls power supply to the outlet 70 about to be used by a user. The apparatus specifying information may be information capable of achieving such a function. The apparatus specifying information may be, for example, discrimination information discriminating a plurality of control apparatuses 30 from each other. Further, as is clear from the description using FIG. 3, the outlet 70 and the control apparatus 30 are previously associated with each other. Therefore, as apparatus specifying information, discrimination information discriminating a plurality of outlets 70 from each other may be usable. Further, an installation location of the outlet 70 or an installation location of the control apparatus 30 may be usable as apparatus specifying information.

A user operates the user terminal 40, and performs an operation for inputting apparatus specifying information as described above and also transmitting the input information to the management server 10. There are various achievement means for inputting apparatus specifying information and, for example, the following example is cited.

For example, in an installation location of the outlet 70, code information (a bar code, a two-dimensional code, or the like) unique to each outlet 70 may be provided. Then, a user operates the user terminal 40, reads the code information, and thereby may achieve input of apparatus specifying information.

In addition, in an installation location of the outlet 70, discrimination information of the outlet 70 or discrimination information of the control apparatus 30 that controls power supply to each outlet 70 may be provided. These pieces of discrimination information are configured, for example, by a combination of a number, a character, a symbol, and the like. Then, a user operates the user terminal 40, inputs these pieces of discrimination information, and thereby may achieve input of apparatus specifying information.

In addition, a user may display predetermined map information in the user terminal 40. The map is provided from the management server 10. Then, on the map, a label indicating an installation location of the outlet 70 is displayed. The user selects a predetermined outlet 70 on the map, and thereby, may achieve input of apparatus specifying information.

Note that, the achievement means for input of apparatus specifying information exemplified herein are one example without limitation thereto.

The “charging-content specifying information” includes information required for charging processing and settlement processing to be executed. For example, the charging-content specifying information includes information specifying how much a power amount is charged. The information may be a power amount to be charged itself, may be a duration (minute, hour, or the like) of a time required for executing charging processing, or may be an amount of money (yen or the like) to be paid based on charging processing. A power amount to be charged may be specified by a numerical value of a power amount such as “X [kWh]”.

In addition, the charging-content specifying information may include information specifying a payment method. The payment method includes, as examples, but not limited to, credit card payment, electronic money payment, sending a bill by mail available in a predetermined institution (a bank, a post office, a convenience store, or the like), and the like.

The “user discrimination information” is information (so-called user ID) discriminating, from each other, a plurality of users using a charging service achieved by the management server 10. Discrimination information of a user may be a name, an address, a phone number, a mail address, and the like of the user or a combination of these items, or may be a combination of a number, a character, a symbol, and the like issued by the management server 10. For example, a user hoping to use a charging service previously operates the user terminal 40 or the like, and executes user registration processing. In the user registration processing, a name, an address, a phone number, a mail address, credit card information, electronic money information, and the like of the user are registered. Further, in the user registration processing, information required for user authentication may be registered. The information includes, as examples, but not limited to, a password, biological information, (face information, finger print information, iris information, voice print information, and the like), and the like.

A user operates the user terminal 40, and accesses the management server 10 via a predetermined web page or an application. Then, the user inputs, on a screen of the web page or the application, the above-described apparatus specifying information, charging-content specifying information, discrimination information of the user, and the like, and performs an operation for transmitting the input pieces of information to the management server 10.

The control execution unit 12 executes processing of controlling the control apparatus specified by apparatus specifying information acquired by the acquisition unit 11. Specifically, the control execution unit 12 executes (1) processing of starting power supply to the outlet 70, and (2) settlement processing for a charging service.

In processing of starting power supply to the outlet 70, the control execution unit 12 transmits, to the control system 20 that controls the control apparatus 30 specified by the apparatus specifying information acquired by the acquisition unit 11, a request for starting power supply to a predetermined outlet 70 controlled by the control apparatus 30. Further, the control execution unit 12 transmits, to the control system 20, control content information indicating a charging power amount or a charging time determined by the charging-content specifying information acquired by the acquisition unit 11.

The charging power amount indicates a power amount to be charged. The power amount to be charged may be indicated by a numerical value of a power amount such as “X [kWh]”. The charging time indicates a duration (minute, hour, and the like) of a time required for executing charging processing. These values are indicated by the above-described charging-content specifying information. Note that, when, in the charging-content specifying information, an amount of money (yen or the like) to be paid based on charging processing is indicated, the control execution unit 12 can compute a power amount to be charged, based on the amount of money and a power unit price. A determination means for the power unit price is not specifically limited.

In settlement processing for a charging service, the control execution unit 12 acquires, from the control apparatus 20, a measurement value of a power use amount via the outlet 70 during a period from start of power supply to the outlet 70 to stop of power supply to the outlet 70. Then, the control execution unit 12 executes, based on the acquired measurement value, settlement processing for a user. Specifically, the control execution unit 12 computes a billing amount, based on the acquired measurement value and a power unit price. Then, the control execution unit 12 executes settlement processing of receiving payment for the billing amount.

When a payment method is previously specified, the control execution unit 12 executes settlement processing based on the payment method. When a payment method is not previously specified, the control execution unit 12 provides a billing amount via the user terminal 40, also receives specification of a payment method, and executes settlement processing, based on the specified payment method. Settlement processing based on various types of payment methods can be achieved by using any well-known technique

The management server 10 is preferably configured in such a way that discrimination information of a user is not transmitted to the control system 20. Even when discrimination information of a user is not transmitted from the management server 10 to the control system 20, the above-described processing can be executed. When a configuration is made in this manner, protection of personal information is achieved.

Note that, it is necessary for the management server 10 to associate, for settlement processing, a measurement value measured by the control apparatus 30 with a user. The association can be achieved by using, as association information, any information other than discrimination information of a user. In other words, the management server 10 manages discrimination information of a user and any association information in association with each other. Further, in transmission/reception of a measurement value among the control apparatus 30, the control system 20, and the management server 10, the association information is associated with the measurement value. The association information includes, as examples, but not limited to, a transmission time of a power supply start request transmitted from the management server 10 to the control system 20, a request number provided for the request, and the like.

### —Control System 20—

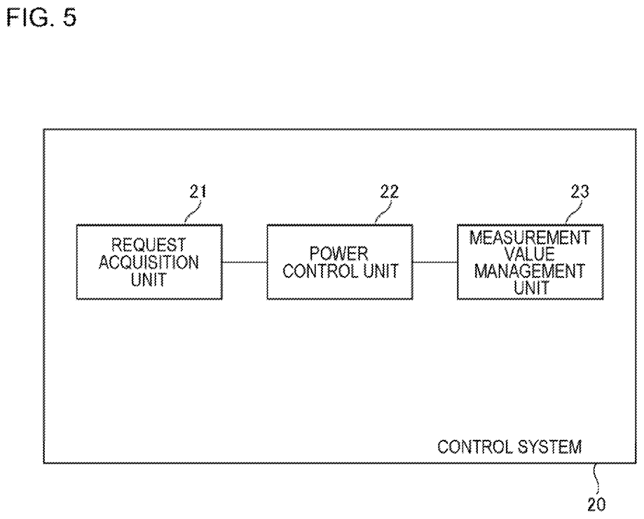

Next, a function configuration of the control system 20 according to the present example embodiment is described in detail. FIG. 5 illustrates one example of a function block diagram of the control system 20. As illustrated, the control system 20 includes a request acquisition unit 21, a power control unit 22, and a measurement value management unit 23. The request acquisition unit 21 acquires, from the management server 10, a request for starting power supply to a predetermined outlet 70 and control content information indicating a charging power amount or a charging time. The request acquisition unit 21 acquires a request and control content information transmitted by the control execution unit 12 described above. The request includes the above-described apparatus specifying information. Based on the apparatus specifying information, the predetermined outlet 70 is determined.

Note that, the control system 20 is preferably configured in such a way as not to acquire, from the management server 10 or the like, discrimination information of a user executing, based on the request, charging processing. When such a configuration is made, in the control system 20, a measurement value (a measurement value of a power use amount via the outlet 70) acquired from the control apparatus 30 and a user are not associated with each other. As a result, protection of personal information is achieved.

The power control unit 22 controls the control apparatus 30 that controls power supply to the predetermined outlet 70, starts power supply to the predetermined outlet 70 according to the request, and also stops power supply to the outlet 70 according to completion of charging processing indicated by control content information.

Herein, one example of processing of the control apparatus 30 based on such control of the power control unit 22 is described. Note that, there is no limitation to the exemplification herein.

The control apparatus 30 controls on/off of current flowing into the outlet 70, i.e., current flowing in an electric wire leading to the outlet 70. The control apparatus 30 includes a switch, for example, attached to an electric wire. The switch can switch, based on electric control, on/off, and includes a function for electrically break an electric wire. Specifically, when the switch is turned on, an electric wire can cause electricity to flow. On the other hand, when the switch is turned off, the electric wire cannot cause electricity to flow.

The control apparatus 30 turns on the switch and starts power supply to the outlet 70 according to control from the control system 20. Further, the control apparatus 30 turns off the switch according to detection of predetermined end timing, and stops power supply to the outlet 70.

The end timing is, for example, timing at which charging of a charging power amount indicated by control content information is completed. The control apparatus 30 includes a measurement instrument that repeatedly measures at least one of current flowing in an electric wire and a current amount. As a configuration of the measurement instrument, any well-known configuration is employable. The control apparatus 30 measures a power use amount via the outlet 70 after turning on the switch according to control of the control system 20, based on a measurement result by the measurement instrument. Then, the control apparatus 30 detects, as the end timing, timing at which the measurement value reaches a charging power amount indicated by the control content information.

In addition, the end timing is, for example, timing at which charging during a charging time indicated by control content information is completed. The control apparatus 30 monitors an elapse time from predetermined start timing, and detects, as the end timing, timing at which the elapse time becomes a charging time indicated by the control content information. The start timing may be timing at which the switch is turned on, or may be timing at which use (charging processing) of power is started.

Further, the control apparatus 30 can repeatedly transmit, to the control system 20 at every predetermined time, while the switch is turned on, at least one of a measurement result based on the measurement instrument and the measurement value. Then, the control apparatus 30 may turn off the switch and stop power supply to the outlet 70 when communication with the control system 20 is not maintained.

In order to achieve this matter, the control apparatus 30 can execute conformation processing of whether communication with the control system 20 is being maintained. The processing is processing, for example, defined in IEEE802.1ag/ITU-T Y.1731. For the confirmation processing, for example, a continuity check (CC) may be used, a loop back (LB) may be used, or a link trace (LT) may be used.

Herein, the CC indicates a matter that a hello packet is mutually transmitted in communication between two apparatuses. Further, the LB indicates a matter that a loop back message is transmitted to an opposite party and it is determined, based on presence of a reply of a loop back response, that communication is being maintained. In this case, any either of parties may transmit a loop back message. Further, the LT is a so-called link trace function. The measurement value management unit 23 acquires, from the control apparatus 30, a measurement value of a power use amount via the outlet 70 during a period from start of power supply to the outlet 70 to stop of power supply to the outlet 70. Then, the measurement value management unit 23 transmits the measurement value to the management server 10. Further, the measurement value management unit 23 registers the measurement value, without association with a user, in association with the outlet 70 or an installation location of the outlet 70.

Then, the measurement value management unit 23 transmits, to the computation system 50 that computes environment load information, the measurement value registered, without association with the user, in association with the outlet 70 or the installation location of the outlet 70. The measurement value management unit 23 may transmit, to the computation system 50, the information via the system cooperation platform 60. In other words, the measurement value management unit 23 may transmit the information to the system cooperation platform 60. Then, the system cooperation platform 60 may transmit the information to the computation system 50.

The computation system 50 can compute, based on the information, an integration value of measurement values by region, and compute, based on the integration value, environment load information by region. Note that, the integration value of measurement values by region may be computed by the control system 20 or the system cooperation platform 60, and the computation result may be transmitted to the computation system 50.

Environment load information computed by the computation system 50 includes a greenhouse effect gas emission amount (carbon emission amount), and the like. For example, a computation method (a function or the like) of computing a greenhouse effect gas emission amount (carbon emission amount) from an integration value of measurement values is previously generated. Then, the computation system 50 computes, based on the computation method and the integration value of measurement values, a greenhouse effect gas emission amount (carbon emission amount).

Note that, the computation system 50 can compute at least one of so-called scopes 1 to 3, for example, an entire emission amount. The computation system 50 can acquire, by using any means, another piece of information required for the computation. According to the following example embodiment, a means for acquiring information indicating a power type of used power, a power supply source, and the like is described.

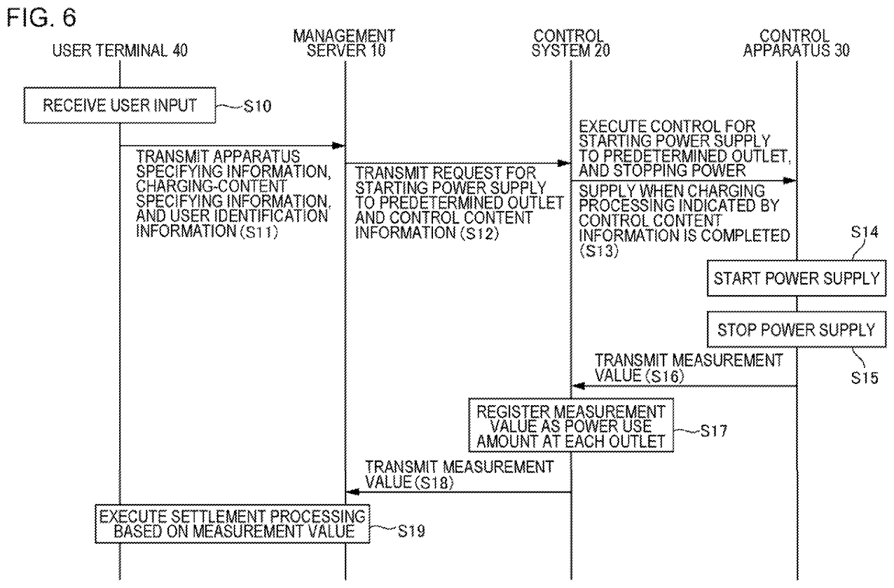

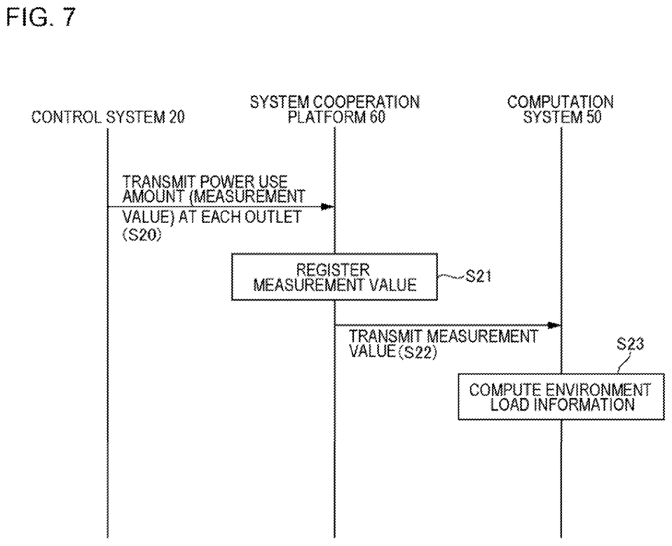

Next, by using a sequence diagram in FIGS. 6 and 7, one example of a flow of processing of a system including the management server 10 and the control system 20 is described.

First, as illustrated in the sequence diagram in FIG. 6, the user terminal 40 receives various types of input from a user using a charging service (S10). The user performs the input immediately before using a certain outlet 70. In other words, the user positions his/her own electric car 80 near the outlet 70, ensures a state where the outlet 70 is usable (a state where another user does not use the outlet 70, and once power supply to the outlet 70 is started, charging to the own electric car 80 can be started at any time), and performs the input.

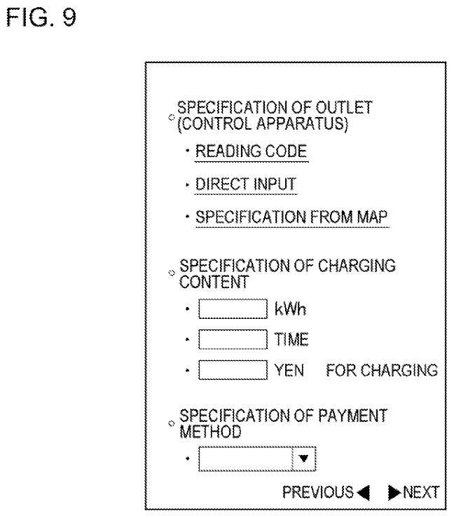

The user can perform input in S10, for example, via a user interface (UI) screen, as illustrated in FIG. 9, displayed in the user terminal 40. The UI screen illustrated in FIG. 9 is configured in such a way as to receive specification of the outlet 70 (control apparatus 30) to be used, specification of a content of charging processing to be executed, and specification of a payment method.

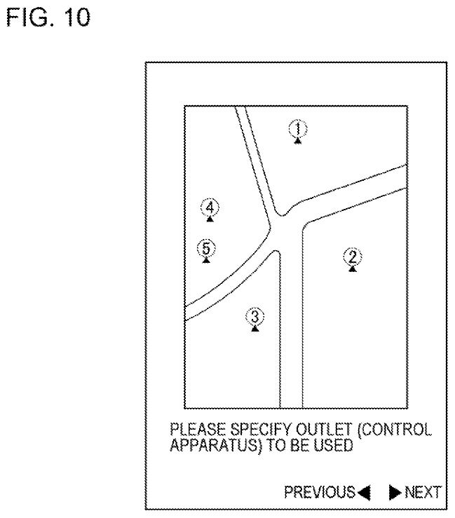

In a case of the example illustrated in FIG. 9, specification of the outlet 70 (control apparatus 30) to be used can be achieved by any of “reading a code”, “direct input”, and “specification from a map”. When “reading a code” is selected, a code read function of the user terminal 40 is started, and a display of the user terminal 40 functions, for example, as a finder of a camera to be used capturing an image of a code. Then, by using a well-known technique, reading a code via the user terminal 40 can be achieved. When “direct input” is selected, a screen including a UI component for directly inputting discrimination information of the control apparatus 30 or the outlet 70 is displayed. When “specification from a map” is selected, for example, as illustrated in FIG. 10, a neighboring map being a map where a location of the outlet 70 is clearly indicated is displayed. A user can specify one outlet 70 on the map. Note that, in a case where many outlets 70 are installed in a certain place, when one location is specified on a relatively wide-area map as illustrated in FIG. 10, thereafter, transition is made to a more detailed map indicating an installation location of each of a plurality of outlets 70 installed in the specified location, and one outlet 70 may be specified on the detailed map. Based on a location of the user terminal 40 determined by a GPS function or the like included in the user terminal 40, a range of a map (a neighboring map) displayed in the user terminal 40 can be determined.

Further, in the case of the example in FIG. 9, a charging content can be specified by any of specification of a power amount to be charged, specification of a charging time, and an amount of money to be paid. Further, in the case of the example in FIG. 9, a payment method can be selected by a drop-down list.

Note that, the example illustrated in FIG. 9 is merely one example without limitation. Input of a user may be received based on a means different from the means illustrated in FIG. 9.

After receiving the input of a user in S10, the user terminal 40 transmits, to the management server 10, apparatus specifying information, charging-content specifying information, and discrimination information of the user according to the input (S11). The apparatus specifying information is information specifying the control apparatus 30 that controls power supply to the outlet 70 about to be used by the user. The charging-content specifying information is information specifying a power amount to be charged, a time required for executing charging processing, an amount of money to be paid in charging processing, a payment method, and the like.

Next the management server 10 transmits, to the control system 20, a request for starting power supply to the predetermined outlet 70 controlled by the control apparatus 30 specified by the apparatus specifying information, and control content information (S12). The control content information indicates a charging power amount or a charging time.

Note that, the management server 10 may execute various pieces of processing before S12, and execute processing in S12 according to the result. The management server 11 may execute, for example, user authentication processing by using discrimination information of the user. Then, the management server 10 may execute processing in S12 when succeeding in the authentication processing. The user authentication is achieved by using any well-known technique.

Next, the control system 20 controls the predetermined control apparatus 30 according to the request from the management server 10, starts power supply to the predetermined outlet 70, and also stops power supply to the outlet 70 according to completion of charging processing indicated in the control content information (S13). The control apparatus 30 starts power supply to the predetermined outlet 70 according to the control (S14), and stops power supply to the outlet 70 according to detection of predetermined end timing (S15). The end timing is, for example, timing at which charging of a charging power amount indicated by the control content information is completed, timing at which charging during a charging time indicated by the control content information is completed, or the like.

After S15, the control apparatus 30 transmits, to the control system 20, a measurement value of a power use amount via the outlet 70 during a period from the timing at which power supply is started in S14 to the timing at which power supply is stopped in S15 (S16). The control system 20 registers the measurement value, without association with the user, in association with the outlet 70 or an installation location of the outlet 70 (S17). Further, the control system 20 transmits the measurement value to the management server 10 (S18).

Next, the management server 10 communicates with the user terminal 40, and executes, based on the acquired measurement value, settlement processing (S19). Specifically, the management server 10 computes a billing amount, based on the acquired measurement value and a power unit price. Then, the management server 10 executes settlement processing of receiving payment of the billing amount. When a payment method is previously specified, the management server 10 executes settlement processing based on the payment method. When a payment method is not previously specified, the management server 10 provides a billing amount via the user terminal 40, receives specification of the payment method, and executes settlement processing based on the specified payment method. For settlement processing based on various types of payment methods can be achieved by using any well-known technique.

Thereafter, as illustrated in the sequence diagram in FIG. 7, the control system 20 transmits, to the system cooperation platform 60, at any timing, the measurement value registered, without association with the user, in association with the outlet 70 or an installation location of the outlet 70 (S20). The control system 20 may execute processing in S20, for example, according to a request from the system cooperation platform 60, may execute processing in S20 according to coming of predetermined timing (e.g., timing of every hour, timing of every twelve hours, timing of every other day, or the like), may execute processing in S20 according to a user operation, or may execute processing in S20 according to at other timing.

The control system 20 may transmit, to the system cooperation platform 60, a set of measurement values of charging processing at each time in each outlet 70, or may transmit, to the system cooperation platform 60, the data by being collected by region. Further, the control system 20 may compute an integration value of measurement values by region, and transmit the integration value to the system cooperation platform 60. Further, the control system 20 may transmit a plurality of these values to the system cooperation platform 60.

The system cooperation platform 60 registers the measurement value received from the control system 20 (S21). The system cooperation platform 60 may register, for example, based on an installation location of the outlet 70, the received measurement value by region. Further, the system cooperation platform 60 may integrate measurement values by region.

Then, the system cooperation platform 60 transmits the measurement value by region to the computation system 50 (S22). The system cooperation platform 60, for example, may execute processing in S22 according to a request from the computation system 50, may execute processing in S22 according to coming of predetermined timing (e.g., timing of every hour, timing of every twelve hours, timing of every other day, or the like), may execute processing in S22 according to a user operation, or may execute processing in S22 according to other timing.

The system cooperation platform 60 may transmit, to the computation system 50, a set of measurement values of charging processing at each time in each outlet 70, or may transmit, to the computation system 50, the data by being collected by region. Further, the system cooperation platform 60 may compute an integration value of measurement values by region, and transmit the integration value to the computation system 50. Further, the system cooperation platform 60 may transmit a plurality of these values to the computation system 50.

The computation system 50 computes, based on the received information, environment load information by region (Sa23). The environment load information by region computed by the computation system 50 includes a greenhouse effect gas emission amount (carbon emission amount), and the like. For example, a computation method (a function or the like) of computing a greenhouse effect gas emission amount (carbon emission amount) from an integration value of measurement values is previously generated. Then, the computation system 50 computes, based on the computation method and the integration value of measurement values, a greenhouse effect gas emission amount (carbon emission amount).

Note that, the computation system 50 can compute at least one of so-called scopes 1 to 3, for example, an entire emission amount. The computation system 50 can acquire, by using any means, another piece of information required for the computation.

### “Advantageous Effect”

According to the management server 10 of the present example embodiment, an advantageous effect (establishment of an electricity stealing prevention means, establishment of a settlement means for power use, and the like) similar to that of the first and second example embodiments is achieved.

Further, according to the present example embodiment, diffusion of discrimination information of a user can be reduced to a minimum level. In other words, according to the present example embodiment, discrimination information of a user is handled only by the user terminal 40 and the management server 10 among the components illustrated in FIG. 3, and therefore transfer of the discrimination information of the user to other components (the control system 20, the control apparatus 30, the computation system 50, and the system cooperation platform 60) can be reduced. As a result, personal information of a user can be sufficiently protected. Further, while the protection is achieved, computation of environment information such as a greenhouse effect gas emission amount can be achieved.

Further, a business operator providing a charging service using the outlet 70 can make a predetermined contract with an administrator of a facility, for example, such as an amusement park, a supermarket, a coin-operated parking lot, and a month-to-month parking lot, and install the outlet 70 in a parking lot and the like of these facilities. An administrator of a facility can acquire a visitor and a customer for a purpose of a charging service. Further, a business operator providing a charging service can increase a profit via the charging service. In this manner, a preferable result can be achieved for both of an administrator of a facility and a business operator providing a charging service. As a result, an increase in the number of business operators providing the charging service and the number of facilities in which an installation of the outlet 70 is permitted is expected, and thereby further prevalence of a charging facility for an electric car is expected.

Further, in a case of a charging service according to the present example embodiment, communication between the control apparatus 30 (a smart meter or the like) and the electric car 80, or determination of the electric car 80 are not required. Therefore, handling of information relating to the electric car 80 by the control apparatus 30 and the control system 20 can be avoided. As a result, protection of personal information is further achieved.

### Fourth Example Embodiment

According to the present example embodiment, a user can further specify a power type to be purchased. Hereinafter, description thereof is made in detail.

An acquisition unit 11 of a management server 10 acquires, from a user terminal 40, charging-content specifying information further specifying a power type.

The “power type” may include “renewable energy power” and “other power”. The renewable energy power is power generated by natural energy such as sunlight, wind power, water power, and terrestrial heat. The other power is power generated by a fossil fuel such as petroleum, coal, and natural gas.

As another example of classification of power types, the “renewable energy power” may be further segmentalized according to a type of natural energy used for power generation such as photovoltaic power, wind force-electric power, hydroelectric power, and terrestrial heat-electric power. Further, the “other power” may be further segmentalized according to a type of fuel used for power generation such as petroleum-electric power, coal-electric power, and natural gas-electric power.

As described according the third example embodiment, a user operates the user terminal 40, and accesses the management server 10 via a predetermined web page or an application. Then, the user inputs, on a screen of the web page or the application, apparatus specifying information, charging-content specifying information, discrimination information of a user, and the like, and performs an operation for transmitting the input pieces of information to the management server 10. According to the present example embodiment, a power type can be included in the charging-content specifying information input and transmitted/received in this manner.

A power type which can be sold (handled) by a business operator providing a charging service is previously determined. In the web page or the application described above, power types which can be sold by a business operator providing a charging service are displayed, and user input for specifying one of the power types can be received.

Note that, a unit price may be different with respect to each power type. Further, contents of a service to be received for each power type may be different from each other. A user purchasing, for example, renewable energy power may be given an eco-point, or may be provided with an eco-coupon (a discount coupon or the like).

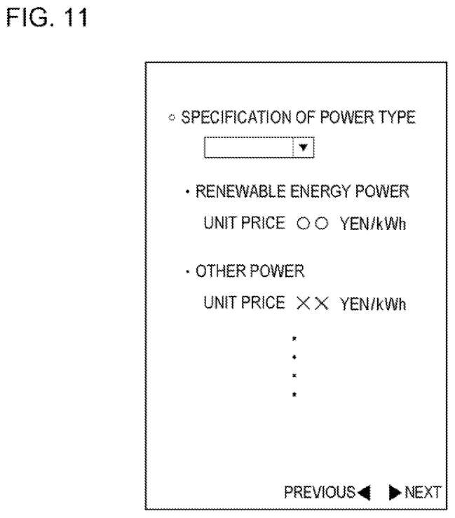

A user can perform input for specifying a power type, for example, via a UI screen as illustrated in FIG. 11 displayed in the user terminal 40. On the UI screen illustrated in FIG. 11, a unit price of each power type is displayed, and thereby selection by a user is assisted. Note that, another piece of information other than a unit price may be displayed.

A control execution unit 12 execute, based on a specified power type, settlement processing. When, for example, a unit price is different with respect to each power type, the control execution unit 12 computes a billing amount, based on a unit price of a specified power type and a measurement value acquired from a control system 20. Further, when an eco-point is given to or an eco-coupon (a discount coupon or the like) is provide for a user purchasing renewable energy power, the control execution unit 12 gives a point, issues a coupon, or do such a thing. These pieces of processing can be achieved by using a well-known technique.

Further, the control execution unit 12 transmits, to the control system 20, information indicating a power type to be purchased, in addition to a request for starting power supply to a predetermined outlet 70, and charging-content specifying information.

The control system 20 registers a measurement value received from a control apparatus in association with information indicating a purchased power type. Further, the control system 20 transmits the measurement value received from the control apparatus 30 to a system cooperation platform 60, in association with information indicating the purchased power type.

The control system 20 may integrate measurement values for each power type, and transmit the result to the system cooperation platform 60. The control system 20 may integrate measurement values by region and for each power type, and transmit the results to the system cooperation platform 60.

In this manner, a request acquisition unit 21 of the control system 20 can acquire control content information further indicating a power type of power to be charged. Then, a measurement value management unit 23 can transmit, to the system cooperation platform 60, information indicating a power type

The system cooperation platform 60 transmits, to a computation system 50, the received information. The system cooperation platform 60 may integrate measurement values for each power type, and transmit the result to the computation system 50. The system cooperation platform 60 may integrate measurement values by region and for each power type, and transmit the results to the computation system 50.

Based on the information, the computation system 50 can recognize how much power of each power type is purchased in each region. Then, the computation system 50 can compute, based on the content, environment load information by region. For example, a computation method (a function or the like) of computing, for each power type, a greenhouse effect gas emission amount (carbon emission amount) from an integration value of measurement values is previously generated. Then, the computation system 50 computes, based on the computation method for each power type and the integration value of measurement values for each power type, a greenhouse effect gas emission amount (carbon emission amount) with respect to each power type.

Other configurations of the management server 10, the control system 20, the control apparatus 30, the user terminal 40, the computation system 50, the system cooperation platform 60, the outlet 70, and an electric car 80 according to the present example embodiment are similar to those of the first to third example embodiments.

According to the present example embodiment, an advantageous effect similar to that of the first to third example embodiments is achieved. Further, according to the present example embodiment, a user can select, at a time of charging using the outlet 70, power to be purchased among a plurality of types of power. Based on such a user-friendly function, an increase in the number of users using the charging service is expected.

Further, according to the present example embodiment, a power type purchased by a user is managed, and thereby the managed power type can be used for computing environment load information. As a result, higher accurate and useful environment load information can be computed.

### Fifth Example Embodiment

According to the present example embodiment, a user can further specify a power supply source. Hereinafter, description thereof is made in detail.

An acquisition unit 11 of a management server 10 acquires, from s user terminal 40, charging-content specifying information further specifying a power supply source.

The “power supply source” is a power retailing business operator. According to the present example embodiment, a user can select, when receiving a charging service by using a certain outlet 70, from what power retailing business operator power is purchased.

While there are various configurations for the acquisition unit 11 according to the present example embodiment, the following one example is described.

First, a user receiving a charging service using the outlet 70 installed by a first business operator operates his/her own user terminal 40, and accesses, via a predetermined web page or an application provided by the first business operator, the management server 10 managed by the first business operator. Then, the user specifies a power supply source on a screen of the web page or the application. In other words, the user selects from what power retailing business operator power is purchased.

A power retailing business operator (power supply source) which can sell power via the outlet 70 installed by the first business operator is previously determined. The power retailing business operator is determined, for example, based on a contract or the like between the first business operator and another power retailing business operator. In the web page or the application, selectable power retailing business operators are displayed, and user input for specifying one of the power retailing business operators can be received.

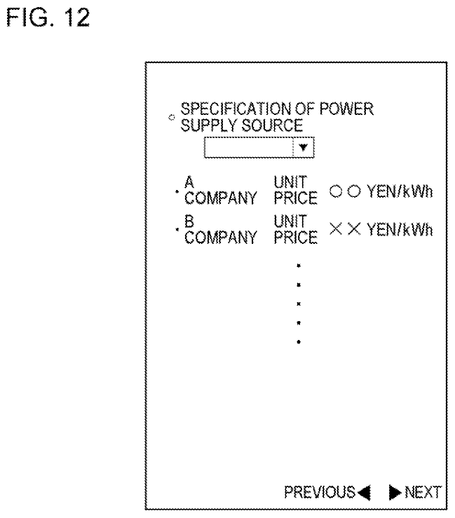

A user can perform input for specifying a power supply source via a UI screen as illustrated in FIG. 12 displayed in the user terminal 40. On the UI screen illustrated in FIG. 12, a unit price of each power supply source is displayed, and thereby selection by the user is assisted. Note that, another piece of information other than the unit price may be displayed.

When the first business operator is specified by the user input, the user inputs, on the web page or the application, charging-content specifying information. On the other hand, when another power retailing business operator is selected, transition is made to a predetermined web page or an application provided by the selected power retailing business operator. In the predetermined web page or the application provided by the first business operator, for example, a link for transition to the predetermined web page or the application provided by the another power retailing business operator is set up. Then, the user inputs charging-content specifying information on the predetermined web page or the application provided by the another power retailing business operator. The user terminal 40 accesses, via the predetermined web page or the application provided by the another power retailing business operator, a management server managed by the another power retailing business operator.

Both of the management server 10 managed by the first business operator and the management server 10 managed by another power retailing business operator include the function described according to the first to fourth example embodiments, and execute processing described according to the first to fourth example embodiments.

Further, a control execution unit 12 transmits, to a control system 20, information indicating a power supply source, in addition to a request for starting power supply to a predetermined outlet 70 and charging-content specifying information.

The control system 20 registers a measurement value received from a control apparatus in association with information indicating a power supply source. Further, the control system 20 transmits, to a system cooperation platform 60, the measurement value received from the control apparatus 30 in association with the information indicating a power supply source. The control system 20 may integrate measurement values for each power supply source, and transmit the result to the system cooperation platform 60. The control system 20 may integrate measurement values by region and for each power supply source, and transmit the results to the system cooperation platform 60.

In this manner, a request acquisition unit 21 of the control system 20 can acquire control content information further indicating a power supply source of power to be charged. Then, a measurement value management unit 23 can transmit information indicating a power supply source to the system cooperation platform 60.

The system cooperation platform 60 transmits, to a computation system 50, the received information. The system cooperation platform 60 may integrate measurement values for each power supply source, and transmit the result to the computation system 50. The system cooperation platform 60 may integrate measurement values by region and for each power supply source, and transmit the results to the computation system 50.

Based on the information, the computation system 50 can recognize how much power of each power supply source is purchased in each region. Then, the computation system 50 can compute, based on the content, environment load information by region. For example, a computation method (a function or the like) of computing, for each power supply source, a greenhouse effect gas emission amount (carbon emission amount) from an integration value of measurement values is previously generated. Then, the computation system 50 computes, based on the computation method for each power supply source and the integration value of measurement values for each power supply source, a greenhouse effect gas emission amount (carbon emission amount) with respect to each power supply source.

Other configurations of the management server 10, the control system 20, the control apparatus 30, the user terminal 40, the computation system 50, the system cooperation platform 60, the outlet 70, and an electric car 80 according to the present example embodiment are similar to those of the first to fourth example embodiments.

According to the present example embodiment, an advantageous effect similar to that of the first to fourth example embodiments is achieved. Further, according to the present example embodiment, a user can select, at a time of charging using the outlet 70, power to be purchased from any power retailing business operator among a plurality of power retailing business operators. Based on such a user-friendly function, an increase in the number of users using the charging service is expected.

Note that, according to the present example embodiment, even in charging using the same outlet 70, a power retailing business operator selling power to a user via the outlet 70 may be different in each user or in charging of each time. Such a pattern can be achieved, for example, by using a smart contract.

Further, according to the present example embodiment, a user can manage a power supply source in which power is purchased in each outlet 70, and use this matter in order to compute environment load information. As a result, higher accurate and useful environment load information can be computed.

### Sixth Example Embodiment

According to the present example embodiment, a user can further specify at least one of a power type and a power supply source. In other words, an acquisition unit 11 of a management server 10 acquires charging-content specifying information further specifying at last one of a power type and a power supply source. Then, a request acquisition unit 21 of a control system 20 acquires control content information further indicating at least one of a power type and a power supply source of power to be charged. A measurement value management unit 23 transmits, via a system cooperation platform 60 to a computation system 50, the information indicating at least one of a power type and a power supply source. The computation system 50 computes, based on at least one of the power type and the power supply source, environment load information. Details thereof are as described according to the fourth and fifth example embodiments.

Other configurations of the management server 10, the control system 20, a control apparatus 30, a user terminal 40, the computation system 50, the system cooperation platform 60, an outlet 70, and an electric car 80 according to the present example embodiment are similar to those of the first to fifth example embodiments. According to the present example embodiment, an advantageous effect similar to that of the first to fifth example embodiment is achieved.

### Seventh Example Embodiment

According to the present example embodiment, a business operator providing a charging service sells renewable energy power via an outlet 70. The business operator may sell, for example, photovoltaic power generated by sunlight. In renewable energy power and photovoltaic power, a power generation amount is affected by nature. Therefore, a power price unit is also dynamically changed.

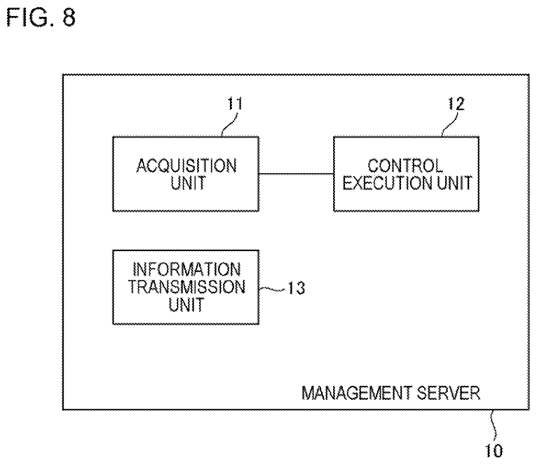

Then, as illustrated in FIG. 8, a management server 10 includes an information transmission unit 13. The information transmission unit 13 determines, based on supply and demand balance information indicating a temporal change of supply and demand balance of power, a time period for recommending charging of power of a first type, and transmits, to a user, advice information recommending charging in the time period.

Power of the first type is renewable energy power or photovoltaic power.

First, the information transmission unit 13 acquires (1) information indicating a temporal change of a generation amount of power of the first type on a certain day, (2) information indicating a temporal change of a power demand amount on a certain day, and (3) information indicating a temporal change of a power supply amount on a certain day. The temporal change of a power supply amount indicates a temporal change of a power supply amount in not only power of the first type but also entire power of a plurality of types. The information transmission unit 13 may generate these pieces of information, or may acquire the information from an external apparatus generating these pieces of information. Generation of these pieces of information is achieved by using any well-known technique.

The “time period for recommending charging of power of a first type” is a time period where the three pieces of information described above satisfy a predetermined condition. In such a time period, a power unit price of power of the first type is expected to be relatively inexpensive.

There are various predetermined conditions, and, for example, a condition in that “a power supply amount exceeds a power demand amount by a reference value (e.g., predetermined percent) or more, and also a power generation amount of power of the first type is equal to or more than a threshold value”, or the like is exemplified.

The information transmission unit 13 can transmit, to a user, advice information by using any means. The information transmission unit 13, for example, may use a push notification function of an application, or may achieve by transmission to a previously-registered mail address.

Other configurations of the management server 10, a control system 20, a control apparatus 30, a user terminal 40, a computation system 50, a system cooperation platform 60, the outlet 70, and an electric car 80 according to the present example embodiment are similar to those of the first to sixth example embodiments.

According to the present example embodiment, an advantageous effect similar to that of the first to sixth example embodiments is achieved. Further, according to the present example embodiment, a time period where a unit price of renewable energy power or photovoltaic power is relatively inexpensive can be computed, and advice information recommending charging in the time period can be provided for a user. Based on such a user-friendly function, an increase in the number of users using the charging service is expected.

Further, renewable energy power is likely to be in over surplus in a day time. Then, in a day time in which power is in over surplus, a power unit price tends to decrease. When advice information is provided for a user as described according to the present example embodiment, the user can charge power relatively inexpensively. Further, when an outlet of 100V or 200V is used, several hours are required for charging. When many outlets 70 are installed in a facility such as an amusement park and a supermarket, the facility can attract a customer for a charging purpose. Then, for several hours in which charging processing is executed, a facility is used, and thereby a sufficient profit can be made. Note that, power charged for the electric car 80 can be used for a purpose other than drive of the electric car 80. When advice information is provided for a user as described according to the present example embodiment, the user can charge power in the electric car 80 relatively inexpensively, and thereby, bring the power back to a home or the like and use the brought power for another purpose. As a result, a reduction effect at a power peak is expected.

### Modified Example

Hereinafter, a modified example applicable to the first to seventh example embodiments is described. According to the modified example, also, an advantageous effect similar to that of the example embodiments described above is achieved.

### First Modified Example

According to the fifth example embodiment, a user was able to select, when receiving a charging service by using a certain outlet 70, from what power retailing business operator power was purchased. Then, according to the fifth example embodiment, a user receiving a charging service using the outlet 70 installed by a first business operator selected from what power retailing business operator power was purchased, via a predetermined web page or an application provided by the first business operator.

According to a first modified example, a user selects from what power retailing business operator power is purchased, via a predetermined web page or an application provided by another business operator coordinating a plurality of power retailing business operators.

Specifically, a user receiving a charging service using the outlet 70 installed by the first business operator first operates a user terminal 40, opens a predetermined web page or an application provided by the another business operator, and thereon, selects from what power retailing business operator power is purchased. In the web page or the application, a link for transition to a web page or an application of the selected power retailing business operator is set up. Therefore, according to the selection by the user, transition is made to the web page or the application of the selected power retailing business operator. Thereafter, the user inputs charging-content specifying information on the web page or the application of the selected power retailing business operator.

### Second Modified Example

According to the example embodiments described above, the control system 20 transmitted, via the system cooperation platform 60, a measurement value to the computation system 50. According to a second modified example, a control system 20 transmits, without via a system cooperation platform 60, a measurement value to a computation system 50.

### Third Modified Example

According to the third example embodiment, a configuration in which the computation system 50 or the system cooperation platform 60 is not included can be made.

While example embodiments of the present invention have been described with reference to the drawings, these example embodiments are exemplification of the present invention, and various configurations other than the above-described configurations are employable. The configurations according to the above-described example embodiments may be combined with each other, or some configurations may be replaced with other configurations. Further, the configurations of the above-described example embodiments may be added with various modifications without departing from the spirit. Further, configurations and processing disclosed according to the above-described example embodiments and modified examples may be combined with each other.

Further, in the sequence diagrams used in the above-described description, a plurality of steps (pieces of processing) are described in order, but an execution order of steps to be executed according to each example embodiment is not limited to the described order. According to each example embodiment, an order of illustrated steps can be modified within an extent that there is no harm in context. Further, the above-described example embodiments can be combined within an extent that there is no conflict in content.

The whole or part of the example embodiments disclosed above can be described as, but not limited to, the following supplementary notes.
1. A management server including:
   an acquisition unit that acquires, from a user terminal, apparatus specifying information specifying a control apparatus that controls power supply to an outlet; and
   a control execution unit that executes processing of controlling the control apparatus specified by the apparatus specifying information.
2. The management server according to supplementary note 1, wherein the control execution unit transmits a request for starting power supply to the outlet to a control system that controls the control apparatus specified by the apparatus specifying information.
3. The management server according to supplementary note 1 or 2, wherein
   the acquisition unit acquires charging-content specifying information specifying a power amount to be charged, a time required for executing charging processing, or an amount of money to be paid in charging processing, and
   the control execution unit transmits, to the control system, control content information indicating a charging power amount or a charging time determined by the charging-content specifying information.
4. The management server according to supplementary note 3 dependent on supplementary note 2, wherein
   the control system that controls the control apparatus
      starts power supply to the outlet according to the request, and
      stops power supply to the outlet according to completion of charging processing indicated by the control content information,
   the acquisition unit acquires discrimination information of a user, and
   the control execution unit
      acquires, from the control system, a measurement value of a power use amount via the outlet during a period from start of power supply to the outlet to stop of power supply to the outlet, and
      executes, based on the acquired measurement value, settlement processing for the user.
5. The management server according to any one of supplementary notes 1 to 4, wherein the control execution unit does not transmit, to the control system, discrimination information of the user.
6. The management server according to any one of supplementary notes 1 to 5, wherein the acquisition unit acquires the charging-content specifying information further specifying at least one of a power type and a power supply source.
7. The management server according to any one of supplementary notes 1 to 6, further including
   an information transmission unit that determines, based on supply and demand balance information indicating a temporal change of supply and demand balance of power, a time period for recommending charging of power of a first type, and transmits, to a user, advice information recommending charging in the time period.
8. A control system including:
   a request acquisition unit that acquires, from a management server, a request for starting power supply to a predetermined outlet and control content information indicating a charging power amount or a charging time; and
   a power control unit that controls a control apparatus that controls power supply to an outlet, starts power supply to the outlet according to the request, and also stops power supply to the outlet according to completion of charging processing indicated by the control content information.
9. The control system according to supplementary note 8, wherein
   the control system does not acquire discrimination information of a user executing, based on the request, charging processing.
10. The control system according to supplementary note 9, further including
   a measurement value management unit that registers, without association with the user, a measurement value of a power use amount via the outlet during a period from start of power supply to the outlet to stop of power supply to the outlet in association with the outlet or an installation location of the outlet.
11. The control system according to supplementary note 10, wherein
   the measurement value management unit
      transmits, to a computation system that computes environment load information, the measurement value registered, without association with the user, in association with the outlet or an installation location of the outlet.
12. The control system according to supplementary note 11, wherein
   the computation system computes, based on an integration value of the measurement value by region, the environment load information by region.
13. The control system according to supplementary note 11 or 12, wherein
   the request acquisition unit acquires the control content information further indicating at least one of a power type of power to be charged and a power supply source,
   the measurement value management unit transmits, to the computation system, information indicating at least one of the power type and the power supply source, and
   the computation system computes, based on at least one of the power type and the power supply source, the environment load information.
14. The control system according to any one of supplementary notes 11 to 13, wherein
   the environment load information includes a carbon emission amount.
15. The control system according to any one of supplementary notes 11 to 14, wherein
   the measurement value management unit transmits, to the computation system, the measurement value via a system cooperation platform that manages, by region, information required for computing the environment load information.
16. A management method including,
   by one or more computers:
      acquiring, from a user terminal, apparatus specifying information specifying a control apparatus that controls power supply to an outlet; and
      executing processing of controlling the control apparatus specified by the apparatus specifying information.
17. A program for causing a computer to function as:
   an acquisition unit that acquires, from a user terminal, apparatus specifying information specifying a control apparatus that controls power supply to an outlet; and
   a control execution unit that executes processing of controlling the control apparatus specified by the apparatus specifying information.
18. A control method including,
   by one or more computers:
      acquiring, from a management server, a request for starting power supply to a predetermined outlet and control content information indicating a charging power amount or a charging time; and
      controlling a control apparatus that controls power supply to an outlet, starting power supply to the outlet according to the request, and also stopping power supply to the outlet according to completion of charging processing indicated by the control content information.
19. A program for causing a computer to function as:
   a request acquisition unit that acquires, from a management server, a request for starting power supply to a predetermined outlet and control content information indicating a charging power amount or a charging time; and
   a power control unit that controls a control apparatus that controls power supply to an outlet, starts power supply to the outlet according to the request, and also stops power supply to the outlet according to completion of charging processing indicated by the control content information.
10 Management server
11 Acquisition unit
12 Control execution unit
13 Information transmission unit
20 Control system
21 Request acquisition unit
22 Power control unit
23 Measurement value management unit
30 Control apparatus
40 User terminal
50 Computation system
60 System cooperation platform
70 Outlet
80 Electric car
1A Processor
2A Memory
3A Input/output I/F
4A Peripheral circuit
5A Bus

1. A management server comprising:
at least one memory configured to store one or more instructions; and
at least one processor configured to execute the one or more instructions to:
acquire, from a user terminal, apparatus specifying information specifying a control apparatus that controls power supply to an outlet; and
execute processing of controlling the control apparatus specified by the apparatus specifying information.

2. The management server according to claim 1, wherein
the processor is further configured to execute the one or more instructions to transmit a request for starting power supply to the outlet to a control system that controls the control apparatus specified by the apparatus specifying information.

3. The management server according to claim 2, wherein the processor is further configured to execute the one or more instructions to
acquire charging-content specifying information specifying a power amount to be charged, a time required for executing charging processing, or an amount of money to be paid in charging processing, and
transmit, to the control system, control content information indicating a charging power amount or a charging time determined by the charging-content specifying information.

4. The management server according to claim 3, wherein the processor is further configured to execute the one or more instructions to
start power supply to the outlet according to the request,
stop power supply to the outlet according to completion of charging processing indicated by the control content information,
acquire discrimination information of a user,
acquire, from the control system, a measurement value of a power use amount via the outlet during a period from start of power supply to the outlet to stop of power supply to the outlet, and
execute, based on the acquired measurement value, settlement processing for the user.

5. The management server according to claim 4, wherein
the processor is further configured to execute the one or more instructions not to transmit, to the control system, discrimination information of the user.

6. The management server according to claim 4, wherein
the processor is further configured to execute the one or more instructions to acquire the charging-content specifying information further specifying at least one of a power type and a power supply source.

7. The management server according to claim 1, wherein the processor is further configured to execute the one or more instructions to
determine, based on supply and demand balance information indicating a temporal change of supply and demand balance of power, a time period for recommending charging of power of a first type, and
transmit, to a user, advice information recommending charging in the time period.

8. A management method comprising,
by one or more computers:
acquiring, from a user terminal, apparatus specifying information specifying a control apparatus that controls power supply to an outlet; and
executing processing of controlling the control apparatus specified by the apparatus specifying information.

9. The management method according to claim 8, wherein
the one or more computers transmit a request for starting power supply to the outlet to a control system that controls the control apparatus specified by the apparatus specifying information.

10. The management method according to claim 9, wherein the one or more computers
acquire charging-content specifying information specifying a power amount to be charged, a time required for executing charging processing, or an amount of money to be paid in charging processing, and
transmit, to the control system, control content information indicating a charging power amount or a charging time determined by the charging-content specifying information.

11. The management method according to claim 10, wherein the one or more computers
start power supply to the outlet according to the request,
stop power supply to the outlet according to completion of charging processing indicated by the control content information,
acquire discrimination information of a user,
acquire, from the control system, a measurement value of a power use amount via the outlet during a period from start of power supply to the outlet to stop of power supply to the outlet, and
execute, based on the acquired measurement value, settlement processing for the user.

12. The management method according to claim 11, wherein
the one or more computers do not transmit, to the control system, discrimination information of the user.

13. The management method according to claim 11, wherein
the one or more computers acquire the charging-content specifying information further specifying at least one of a power type and a power supply source.

14. The management method according to claim 8, wherein the one or more computers
determine, based on supply and demand balance information indicating a temporal change of supply and demand balance of power, a time period for recommending charging of power of a first type, and
transmit, to a user, advice information recommending charging in the time period.

15. A non-transitory storage medium storing a program for causing a computer to:
acquire, from a user terminal, apparatus specifying information specifying a control apparatus that controls power supply to an outlet; and
execute processing of controlling the control apparatus specified by the apparatus specifying information.

16. The non-transitory storage medium according to claim 15, wherein
the program causing the computer to transmit a request for starting power supply to the outlet to a control system that controls the control apparatus specified by the apparatus specifying information.

17. The non-transitory storage medium according to claim 16, wherein the program causing the computer to
acquire charging-content specifying information specifying a power amount to be charged, a time required for executing charging processing, or an amount of money to be paid in charging processing, and
transmit, to the control system, control content information indicating a charging power amount or a charging time determined by the charging-content specifying information.

18. The non-transitory storage medium according to claim 17, wherein the program causing the computer to
start power supply to the outlet according to the request,
stop power supply to the outlet according to completion of charging processing indicated by the control content information,
acquire discrimination information of a user,
acquire, from the control system, a measurement value of a power use amount via the outlet during a period from start of power supply to the outlet to stop of power supply to the outlet, and
execute, based on the acquired measurement value, settlement processing for the user.

19. The non-transitory storage medium according to claim 18, wherein
the program causing the computer not to transmit, to the control system, discrimination information of the user.

20. The non-transitory storage medium according to claim 18, wherein
the program causing the computer to acquire the charging-content specifying information further specifying at least one of a power type and a power supply source.
